(19) United States
(12) Patent Application Publication
(10) Pub. No.: US 2026/0127516 A1
(43) Pub. Date: May 7, 2026

(54) Adaptive Scheduling and Matching Platform for Technology Assistance Services

(71) Applicant: Ovee Pranav Dharwadkar, Saratoga, CA (US)

(72) Inventor: Ovee Pranav Dharwadkar, Saratoga, CA (US)

(21) Appl. No.: 18/831,902

(22) Filed: Nov. 3, 2025

Related U.S. Application Data
(60) Provisional application No. 63/715,566, filed on Nov. 3, 2024.

(51) Int. Cl. G06Q 10/0631; G06Q 50/20

(52) U.S. Cl. CPC G06Q 10/063112; G06Q 50/20

(57) ABSTRACT

An adaptive scheduling and matching platform for technology assistance services is disclosed. The platform dynamically pairs service providers with service recipients using compatibility scoring, real-time scheduling updates, and feedback-driven optimization.

### CROSS-REFERENCE TO RELATED APPLICATIONS

This application claims the benefit of U.S. Provisional Application No. 63/715,566, filed Nov. 3, 2024.

### FIELD OF THE INVENTION

The present invention relates generally to automated scheduling and intelligent resource-matching systems and, more particularly, to adaptive, AI-driven scheduling platforms for connecting users seeking technology assistance with available instructors based on multiple weighted factors such as expertise, language, and accessibility.

### BACKGROUND OF THE INVENTION

Millions of older adults and novice users face difficulty using everyday digital devices and applications. Traditional customer support solutions are impersonal, time-consuming, and often fail to account for users' language, accessibility, or cultural needs. Additionally, scheduling between available instructors and learners is inefficient and unbalanced.

This invention addresses these limitations by introducing an intelligent, multi-factor scheduling and matching platform that connects tech-savvy youth (“instructors”) with seniors or users seeking digital literacy help (“learners”). The system optimizes instructor selection using criteria including time availability, expertise, language fluency, and accessibility preferences, while continuously learning from user feedback to improve matching accuracy.

### SUMMARY OF THE INVENTION

The Adaptive Scheduling and Matching Platform automates personalized pairing between learners and instructors using a decision model that integrates:
1. Time-based Load Balancing—aligning learner-requested time slots with available instructor calendars.
2. Expertise-based Matching—evaluating instructor skill tags against the learner's requested challenge.
3. Language and Cultural Matching—identifying compatible linguistic or cultural pairings for enhanced communication.
4. Accessibility Considerations—factoring visual, auditory, or cognitive accommodations into instructor ranking.
5. Dynamic Feedback Adaptation—using post-session feedback to adjust instructor weighting and matching accuracy.

The invention integrates live scheduling APIs (e.g., Cal.com), database-driven instructor profiles, and a feedback learning loop that continuously optimizes mentor-learner pairings through AI-assisted scoring and rescheduling.

### BRIEF DESCRIPTION OF THE DRAWINGS

FIG. 1—System architecture overview showing the learner interface, scheduling engine, instructor database, and feedback module.

FIG. 2—Time-availability load-balancing process flow.

FIG. 3—Expertise and language decision matrix.

FIG. 4—Accessibility preference handling and session feedback integration.

FIG. 5—Adaptive feedback learning cycle with waitlist retry and preferred pairing updates.

FIG. 6—Waitlist queue and retry processing flow for unmatched service requests.

FIG. 7—Accessibility compatibility scoring inputs used in provider matching.

FIG. 8—Provider compatibility scoring and selection process.

### DETAILED DESCRIPTION OF THE INVENTION

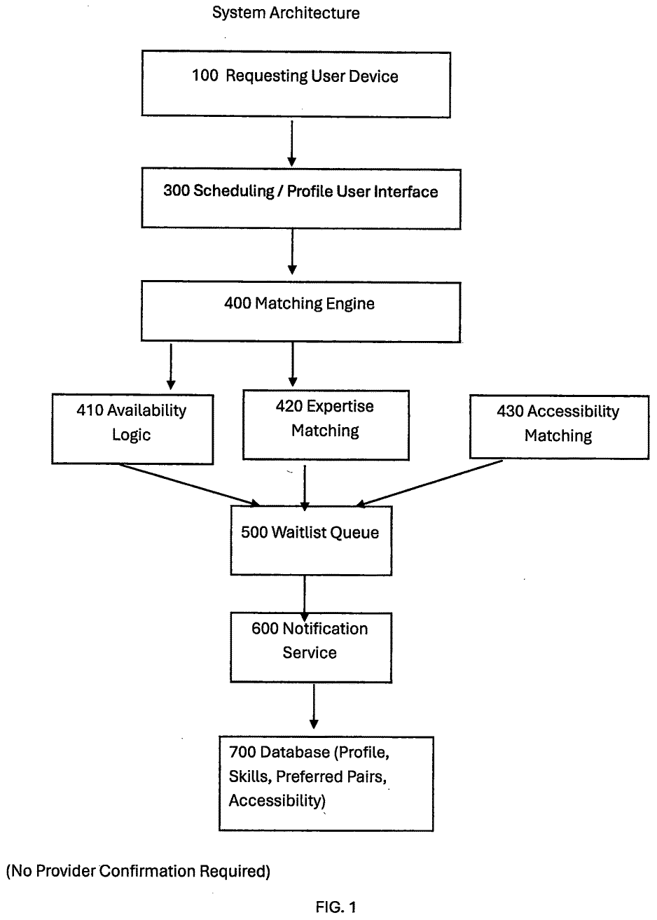

### Referring to FIG. 1—System Architecture Overview

The system includes a user intake interface, matching engine, scheduling API, and feedback module. The intake interface captures learner preferences (help topic, language, accessibility). The matching engine evaluates available instructors based on profile metadata and computes suitability scores. The scheduling service interfaces with external calendars (e.g., Cal.com) to identify open time slots.

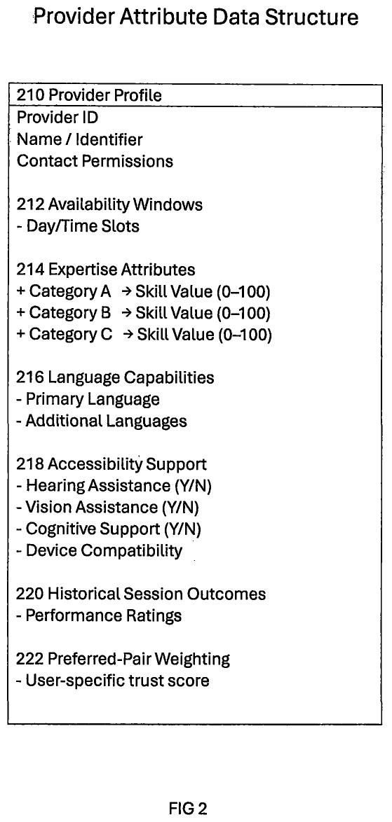

### Referring to FIG. 2—Time-Based Load Balancing

The scheduling engine first filters instructors by requested time window. If multiple instructors are available, the system applies a round-robin or least-loaded algorithm to ensure equitable session distribution.

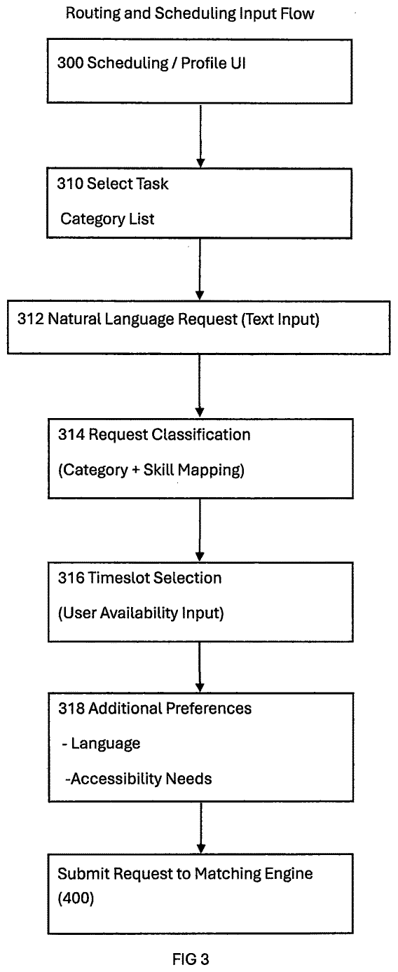

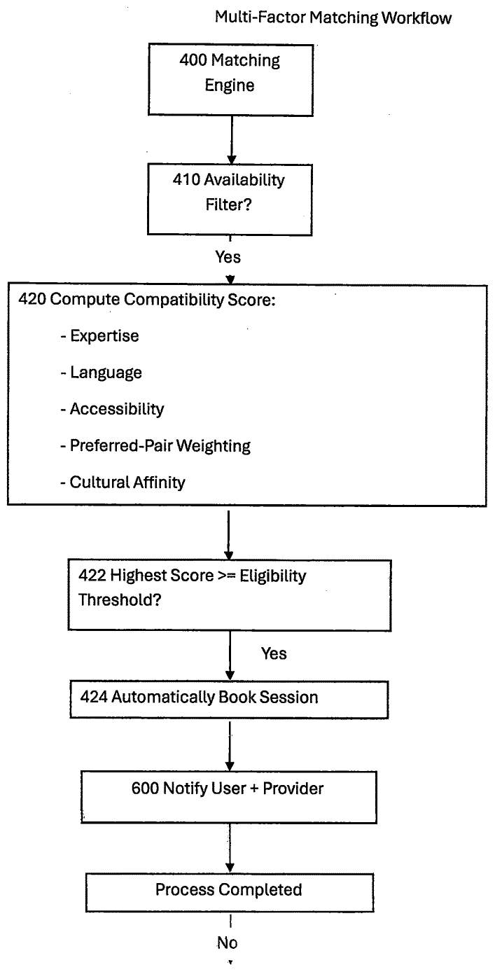

### Referring to FIG. 3—Expertise and Language Matching

Instructor profiles store expertise levels for predefined technology topics. A weighted composite score is generated using the overlap between learner needs and instructor capabilities, with additional bias for shared language or cultural affinity.

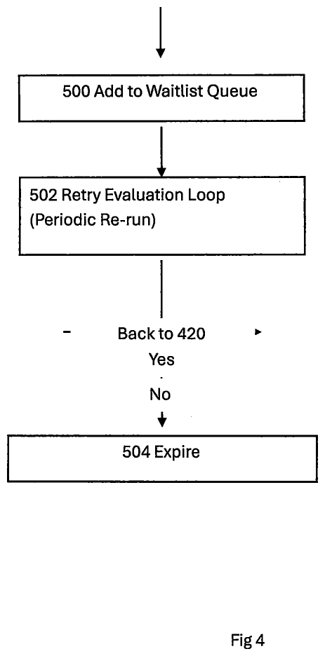

### Referring to FIG. 4—Accessibility and Feedback Integration

Learners may specify accessibility requirements such as text size, captioning, or slower instruction pace. These preferences are treated as additional parameters in the matching algorithm. After each session, both learner and instructor feedback are normalized and integrated into instructor reputation scores, influencing future match weighting.

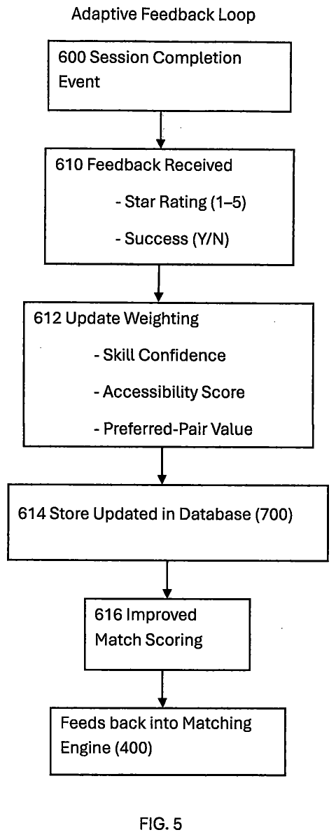

### Referring to FIG. 5—Adaptive Learning and Waitlist Retry Mechanism

When no immediate match is found, the request enters a retry and notify queue. The system periodically checks for new instructor availability and automatically reassigns the session. Successful pairings are logged, and feedback is used to adjust model parameters for future optimization. Over time, the algorithm improves pairing efficiency through reinforcement learning, rewarding high-rated interactions.

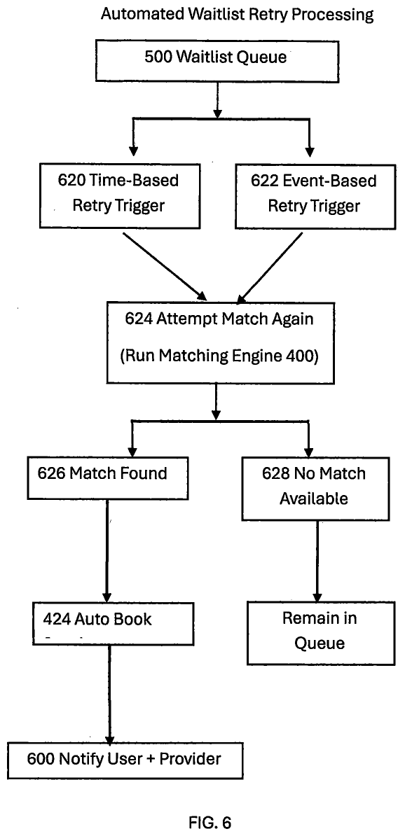

### Referring to FIG. 6—Waitlist Queue and Retry Processing

When a suitable provider is not immediately available for a submitted assistance request, the request is placed into a waitlist queue. The system monitors the queue using both time-based retry triggers and event-based retry triggers, such as changes in provider availability or profile updates. Upon activation of a retry trigger, the matching engine is re-executed to attempt to identify a compatible provider. If a match is found, the system automatically schedules the session and issues notifications to both the user and the selected provider. If no match is available, the request remains in the waitlist queue for subsequent retry evaluation.

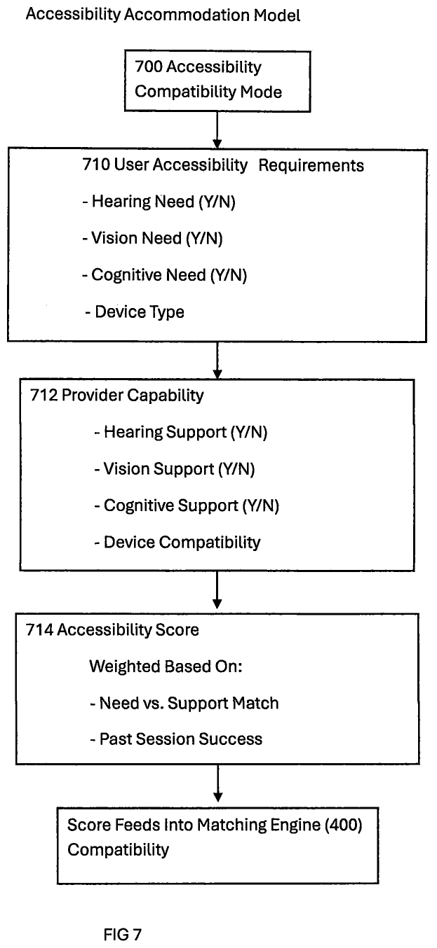

### Referring to FIG. 7—Accessibility Compatibility Evaluation

The system supports an accessibility compatibility mode in which user accessibility requirements are evaluated against provider capability profiles. User requirements may include hearing, vision, or cognitive support needs, as well as device compatibility constraints. Provider profiles specify corresponding support capabilities. An accessibility score is computed based on the alignment between user requirements and provider capabilities, with weighting informed by prior session outcomes. The resulting accessibility score is supplied as an input to the matching engine and influences provider selection decisions.

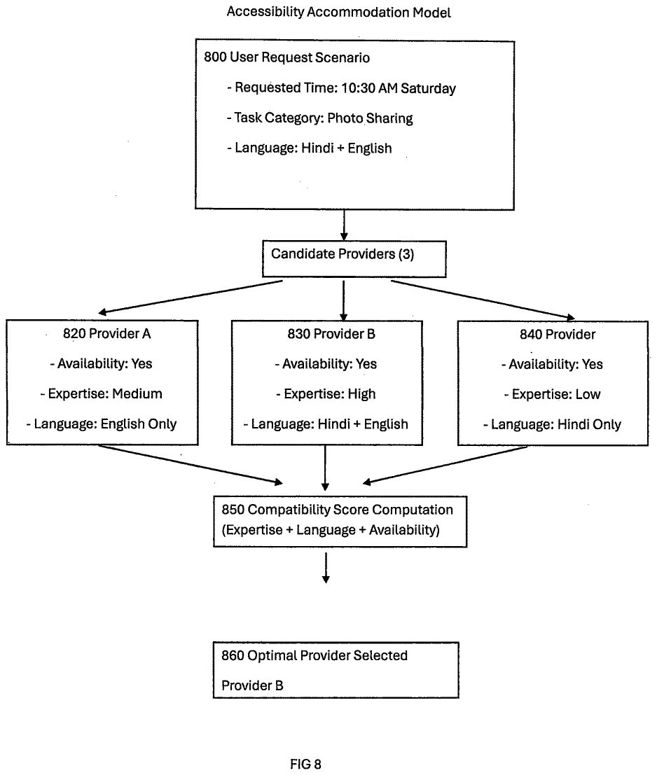

### Referring to FIG. 8—Compatibility Scoring and Provider Selection

For a given user request scenario, the system identifies a set of candidate providers based on availability and baseline eligibility criteria. Each candidate provider is evaluated using a compatibility scoring process that considers factors including expertise level, language compatibility, and scheduling availability. The computed compatibility scores are compared across candidate providers, and an optimal provider is selected based on the relative scoring results. The selected provider is then assigned to the session request for scheduling and fulfillment.

No new matter has been introduced by this substitute specification.

What is claimed is:

1. A computer-implemented method for adaptive scheduling of technology assistance services, comprising receiving availability data, receiving assistance requests, computing compatibility scores, and dynamically assigning service providers.

2. The method of claim 1, wherein the compatibility scores are generated using a machine-learning model.

3. The method of claim 1, wherein assignments are updated in real time.
